(19) United States
(12) Patent Application Publication
(10) Pub. No.: US 2011/0099076 A1
(43) Pub. Date: Apr. 28, 2011

(54) System and method for managing online advertisements

(75) Inventor: David Repas, Nashville, TN (US)

(73) Assignee: Finagle, Inc.

(21) Appl. No.: 12/589,817

(22) Filed: Oct. 28, 2009

(51) Int. Cl. G06Q 30/00

(52) U.S. Cl. 705/14.69

(57) ABSTRACT

A system for managing online advertisements, comprising a network-connected communications interface adapted to receive information from an end user interface and from an advertiser interface, an advertising server coupled to the communications interface, a pricing server coupled to the advertising server and to the communications interface, and a database coupled to the advertising server and the pricing server, wherein the pricing server, upon receiving a request for a price for a proposed online advertisement pertaining to a specific advertisement category from an advertiser interface, computes a price based at least in part on an indicia of available supply of advertisements pertaining to the category, said indicia obtained from the database, and provides the computed price to the requesting advertiser interface, and wherein the advertising server, on receiving a request for online advertisements pertaining to a particular advertisement category from an end user interface, retrieves all or a substantial portion of advertisements pertaining to the advertising category from the database and provides the retrieved advertisements or links thereto to the requesting end user interface, and wherein the advertising server further provides indicia pertaining to an order or method of display to be used in presenting the retrieved advertisements at the requesting end user interface, the indicia provided determined at least in part based on user-specific information stored in the database, is disclosed.

### BACKGROUND OF THE INVENTION

1. Field of the Invention

The present invention relates generally to online advertising, and more specifically to providing a user-centric advertising search service.

2. Discussion to the State of the Art

Advertising has long been focused on mass markets, delivering standardized messages to carefully targeted market segments consisting of large numbers of individual consumers. And advertising generally is a passive affair; advertisers or their partners (such as advertising networks) choose what advertisements to display, when, and to which audiences. The audiences of advertisements are available because they are “there” for their own reasons (usually to view some non-advertising content, such as a television show, a favorite blog, or a sporting event), and are subjected to advertisements as part of the implicit bargain made with the provider or providers of the “real” content. Because of the way in which advertising has grown, consumers generally view most advertisements with suspicion, disdain, or worse. There are exceptions of course, such as the highly visible and eagerly awaited mix of advertisements at marquee events such as championship sports matches. But generally it would be unusual at best to imagine a consumer eagerly looking for advertisements online, ignoring the content around which the advertisements are placed, even refreshing web pages just to see a new set of advertisements.

But this is unfortunate, for despite the generally low esteem in which most consumers hold them, advertisements serve an important informational role in the modem consumer economy. The number of choices of goods and services within any category, and even within very narrowly defined categories, can be quite overwhelming to consumers (especially in an era of globalism and large multinational corporations). Advertisements have the ability to communicate a rich variety of information to consumers about brands and products they may be interested in purchasing or using. Some of the information is factual, but much of the information is intangible and concerns hard-to-define qualities of goods and services, such as the stylistic approach, the degree of luxury and quality to be expected, and the approach or attitude to the market of the providing vendor. It does consumers who need this kind of information a disservice to be unable to get high-quality marketing content when and how they want it; but when advertising is a passively targeted mix of many messages, this is precisely the situation in which consumers find themselves.

Accordingly, it is an object of the present invention to present a system and method for managing advertising that allows consumers to proactively search for advertisements pertinent to topics that they are interested in, and to view the resulting advertisements in a high-quality, rich format that is as good as those typically used for “core content”.

### SUMMARY OF THE INVENTION

According to a preferred embodiment of the invention, a system for managing online advertisements, comprising a network-connected communications interface adapted to receive information from an end user interface and from an advertiser interface, an advertising server coupled to the communications interface, a pricing server coupled to the advertising server and to the communications interface, and a database coupled to the advertising server and the pricing server, is disclosed. According to the embodiment, the pricing server, upon receiving a request for a price for a proposed online advertisement pertaining to a specific advertisement category from an advertiser interface, computes a price based at least in part on an indicia of available supply of advertisements pertaining to the category, said indicia obtained from the database, and provides the computed price to the requesting advertiser interface. Furthermore, according to the embodiment, the advertising server, on receiving a request for online advertisements pertaining to a particular advertisement category from an end user interface, retrieves all or a substantial portion of advertisements pertaining to the advertising category from the database and provides the retrieved advertisements or links thereto to the requesting end user interface, and wherein the advertising server further provides indicia pertaining to an order or method of display to be used in presenting the retrieved advertisements at the requesting end user interface, the indicia provided determined at least in part based on user-specific information stored in the database.

In another preferred embodiment of the invention, a method for managing online advertisements is disclosed, comprising the steps of (a) at a pricing server, receiving a request from an advertiser interface via a communications interface for a proposed online advertisement pertaining to a specific advertisement category, (b) computing a price based at least in part on an indicia of available supply of advertisements pertaining to the category, said indicia obtained from a database coupled to the pricing server and to an advertising server, (c) providing the computed price to the advertising interface, (d) receiving a request for online advertisements pertaining to an advertising category from an end user interface at the advertising server via the communications interface, (e) retrieving all or a substantial portion of advertisements pertaining to the requested advertisement category from the database, (f) providing the retrieved advertisements or links thereto to the requesting end user interface, and (g) providing to the requesting end user interface indicia pertaining to an order or method of display to be used in presenting the retrieved advertisements at the requesting end user interface, wherein the indicia provided are determined at least in part based on user-specific information stored in the database.

### BRIEF DESCRIPTION OF THE DRAWING FIGURES

FIG. 1 is a block diagram of a system for managing online advertisements, according to an embodiment of the invention.

FIG. 2 is a depiction of an advertising category selection web page, according to an embodiment of the invention.

FIG. 3 is an embodiment of an advertisement viewing web page, according to an embodiment of the invention.

FIG. 4 is a process flow diagram illustrating typical end user experience, according to an embodiment of the invention.

FIG. 5 is a process flow diagram illustrating typical advertiser experience, according to an embodiment of the invention.

FIG. 6 is a depiction of a personal summary page, according to an embodiment of the invention.

### DETAILED DESCRIPTION

The inventor provides, in a preferred embodiment, a system for managing online advertisements that allows users to perform searches to find relevant advertisements, rather than passively being subjected to advertisements as they peruse other, non-advertising content. At a high level, the invention consists of providing a text-based search engine interface that users can utilize to select from among a plurality of topics for which advertising collections have been assembled, according to embodiments of the invention. When a particular collection or sub-collection is selected, users are provided with a rich media-based interface for browsing selected collections of advertisements, using a slideshow-like method with extensive user control. Users are allowed to interact meaningfully with advertisements, identifying those that are most useful to the user, deleting undesired advertisements and tagging those that are of particular interest to allow a narrowing of inquiry within the interface. As would be expected in any advertising medium, users are enabled to “click through” to content provided by advertisers (including, but not limited to, specific landing pages in their web sites); in addition, users are enabled to ask questions about products or services featured in specific advertisements, to share collections of preferred advertisements in order to allow collaborative shopping, or to view feeds (news feeds, RSS feeds, and the like) relevant to selected advertisements in order to “drill down” for more information from potentially many sources (all of which can be vetted in advance by advertisers, if desired, according to the invention). According to the invention, advertisements according to topics selected by the user are arranged in order in a “flow”, the order being determined, in a preferred embodiment of the invention, by the relevance of each advertisement to the search query used to generate the flow. In some embodiments, arrangement of advertisements within a flow is also influenced by specific profile information pertaining to a viewing user, or to a class of users to which a viewing user belongs.

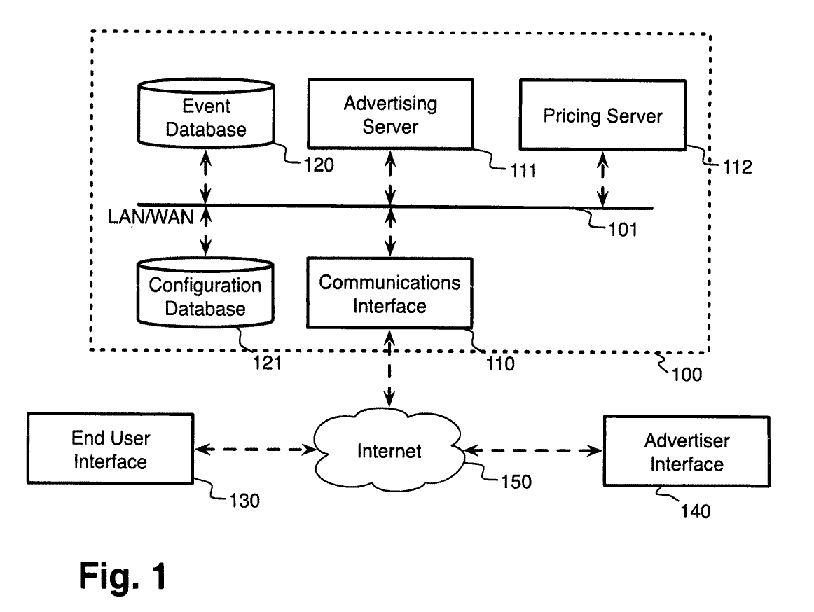

In a preferred embodiment of the invention, and referring to FIG. 1, an advertising management system 100 is connected to the network 150 via communications interface 110. While network 150 is shown in FIG. 1 as the Internet, corresponding to a preferred embodiment of the invention, the invention is not so limited. Any network 150 capable of providing a data, voice or other connection between advertising management system 100 via communications interface 110 to either of end user interface 130 or advertiser interface 140 may be used according to the invention. For example, in some embodiments network 150 is a cellular telephone network or other communications network. Any network 150 suitable for receiving commands from end user interfaces 130 and for presenting advertisements to end users on end user interface 130 can be used to connect end user interface 130 via communications interface 110 to advertising management system 100.

In a preferred embodiment of the invention, communications interface 110 provides a services-oriented interface accessible to end user interface 130 and advertiser interface 140 over the Internet 150 or other suitable network. Many protocols for services-oriented architectures are well-known in the art, including but not limited to Simple Object Access Protocol (SOAP), various extensible markup language (XML) variants, Java Remote Method Invocation (JMRI), and the like. Any protocol of receiving requests from either end user interface 130 or advertiser interface 140 and of passing data back to the same user interfaces may be used without departing from the scope of the invention, as the inventor does not consider services-oriented architectures to be within the inventive scope of the invention. In some embodiments, communications interface 110 is adapted to, on request, directly pass rich media content containing advertisements to end user interface 130 or advertiser interface 140 (collectively, “user interfaces”), such as by passing an mpeg-type file directly to one or more of the user interfaces. In other embodiments, communications interface 110 is adapted to pass uniform resource locator (URL) addresses that enable user interfaces to directly obtain advertisements from third party interfaces for viewing by users. This is, for example, an approach known in the art and used by Flickr™ and Youtube™, among many other third party rich content aggregators. In other embodiments, communications interface 110 provides access to user interfaces via a common low-level web server protocol such as hypertext transfer protocol (HTTP), or via specific applications programming interfaces (APIs) invoked using protocols such as Remote Procedure Calls (RPC) or .NET services. It will be appreciated by one having ordinary skill in the art that there are many ways for communications interface 110 to effectively receive requests and send responses to user interfaces over networks 150.

Communications interface 110 is a software module that is stored and executed on a server computer, such as an Intel x86-based multicore (multiple CPU) machine provided with either a local or a network-based permanent storage subsystem such as a plurality of hard disk drives optionally with RAID (redundant array of independent drives) installed, flash memory drives, or network-attached storage devices, and with local random-access memory (RAM). In some embodiments communications interface 110 is a web server such as Apache, while in others communications interface 110 is an application server such as Tomcat. Again, it will be appreciated by one having ordinary skill in the art that there are many server types and configurations that may be used by communications server 110 without departing from the scope of the invention, as the inventive aspects of the invention do not involve novel web, communications, or server technologies.

In some embodiments of the invention, all of the software components shown in FIG. 1 as elements of advertising management system 100 are stored and executed on a single server machine, typically configured similarly to that just described with reference to communications interface 100. In other embodiments, software components may be distributed differently than shown in FIG. 1 for purposes of convenience in managing the necessary computer equipment (all of the elements shown as parts of advertising management system in FIG. 1 are software components that are stored on, and run on, computers). For example, in some embodiments both databases shown in FIG. 1 are actually present as database files stored within a single database management system such as Oracle™ or Microsoft SQL Server™; even in such cases, the actual database management system may be operating in a clustered server arrangement on several different machines, as is common in the art. Accordingly, the inventor notes that any alternative arrangement to that shown in FIG. 1 that is more convenient or more scalable may be used within the scope of the invention, as long as all of the functional elements described and claimed herein, or their equivalents, are retained in alternative embodiments. Subject to this paragraph, the following description of the relationships between elements of FIG. 1 are exemplary in nature, and do not limit the scope of the invention.

According to an embodiment of the invention, communications interface 110 communicates via local area network 101 to other software components of advertising management system 100, where other software components are operating on distinct computers from that on which communications interface 110 operates. In some embodiments network 101 is a wide area network (that is, a privately-owned or privately-managed network that connects computers located at distinct physical locations, such as a plurality of data centers). And, in yet further embodiments, communications interface 110 is connected to other components via a network 101 that is a hybrid WAN/LAN, where some of the other components are collocated with communications interface 110 and others are located remotely (in a physical sense). Communications between software components executing on servers within advertising management system 100 may be accomplished using proprietary protocols or any of a large number of well-established interprocess communications protocols known in the art, including but not limited to HTML, RPC, SOAP, XML, HTTP, and variants of these. Similar protocols are used in some embodiments in which one or more software components of FIG. 1 are located on a single machine, although in these cases additional low-level protocols are possible, including memory-based semaphores, file-based signaling, system interrupts, and the like. It should be appreciated by one having ordinary skill in the art that there are a multitude of ways for cooperating web-oriented software applications to communicate one with another, and any combination of these, or of these and purpose-built proprietary protocols, may be used for communications between software components of advertising management system 100 without departing from the scope of the invention.

In a preferred embodiment of the invention, communication interface 110 passes requests from user interfaces to advertising server 111, which in some embodiments is a specialized application server using Java servlets to provide services on request. Advertising server 111 obtains data from, or sends data to, configuration database 121 as needed to fulfill requests it receives. When certain requests are received, advertising server 111 sends requests over network 101 to pricing server 112 to obtain new or updated prices for particular advertisements. Event database 120 receives events from communications interface 110, advertising server 111, and pricing server 112. It also, in some embodiments, receives configuration change events from configuration database 121, although in other embodiments configuration database stores information about changes in order to provide an audit trail. The purpose of gathering events in event database 120 is to enable analysis of historical data in order to determine patterns of advertisement placement, viewing, and “conversion” (where conversion means converting an advertisement view into a click-through to underlying content and optionally, where relevant data is provided, converting an advertisement into an actual sale of the product or service advertised). Patterns may relate to particular users, classes of users (either predetermined classes such as demographic groups, or classes determined by analysis, as for example users who repeatedly view advertisements about automotive-related products and frequently convert), particular advertisers, and so forth. By gathering essentially all event-related information, event database 120 provides a rich data source that can be “mined” in an ongoing fashion.

In an embodiment of the invention, end user interface 130 is a mobile browser operating on a mobile phone with data capability, and connected to communications interface 110 via data connection over a mobile telephone network 150. In some cases, network 150 is the Internet, accessed via an Internet gateway resident in a mobile phone network. In another embodiment of the invention, end user interface 130 is a mobile phone without data capability (or with data capability that is not used according to the invention), and network 150 is a mobile telephony network. Advertisements are “played” to end users over a telephony channel or a phone call, and playback controls are optionally accessed via voice commands (as is well established in the art) or via dual-tone multi-frequency (DTMF) commands sent by pressing digits on the mobile phone keypad (as is also well-established in the art).

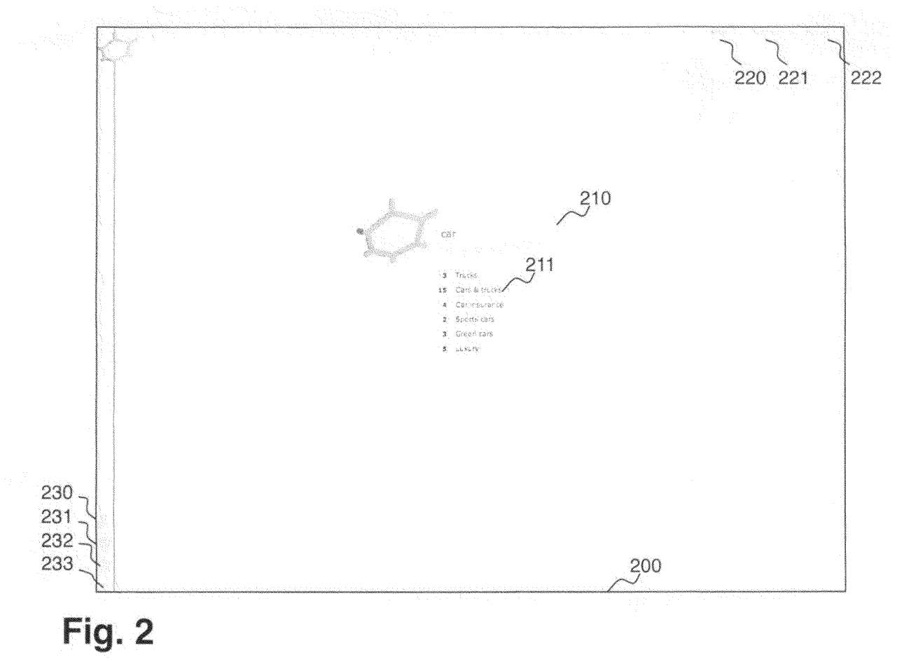

FIG. 2 illustrates a typical advertisement search page 200, according to an embodiment of the invention. Advertisement search page 200, or its equivalent, is provided to end users via end user interface 130. Users are provided a query entry facility 210, which in most embodiments is a text box suitable for typing in search queries, although it need not necessarily be of this form. In response to entry of a query by a user in query entry facility 210, a related categories list 211 is provided to the user. Related categories are selected by advertising server 111 typically following data retrieval (a “data dip”) from configuration database 121. The data dip uses any search query terms provided in search query facility 210 to find pertinent data, typically using a “WHERE” clause in structured query language (SQL), as is well known in the art, although any data lookup method may be used according to the invention. Advertising server 111, in some embodiments, modifies queries sent to configuration database 121 or modifies datasets returned from configuration database 121 based on information about the querying end user or a class of end users to which the querying end user belongs. For example, if an end user has previously indicated that a particular category is definitely not of interest to him, that category may be omitted from displayed lists. Alternatively, the order of presentation of information in related categories list 211 may be altered based on historical viewing patterns of the querying end user or a class of users to which the querying end user belongs. According to the invention, advertisements are assigned to one or more categories, such as “Trucks”, “Cars & trucks”, “Car insurance”, and the like (from the exemplary categories shown in FIG. 2). In a preferred embodiment, category assignments are selected by advertisers when they upload or link their advertisements into advertising management system 100; for example, a car dealer or manufacturer may upload an advertisement for a special promotion on a model of car and specify that it be included in a “Cars” category and a “Special Deals” category (typically, advertisers are able to select from a list of available categories). In other embodiments, advertising server 111 recommends categories to advertisers and allows them to choose from among recommended categories or to manually select other, non-recommended categories. Category recommendations are made using a variety of methods. In one embodiment, category selection history of a given advertiser is used to make recommendations. In another embodiment, text of advertisements to be categorized is scanned for the presence of one or more of a plurality of keywords (normally stored in configuration server 121 but possibly stored only in advertising server 111). Keywords are associated with categories either by manual configuration or by analysis of an aggregate of data from many previous advertisements and category assignments made for them by their owners. It should be appreciated that there a number of techniques familiar to those having ordinary skill in the art for providing recommended categories, without departing from the scope of the invention.

For example, in an embodiment of the invention, instead of a search box 210, users are provided with a list of high-level categories, including for example “Travel”, “Music”, “Automotive”, and the like. When a user selects one of these high-level categories, a set of related subcategories 211 is provided, as for example the “car”-related categories shown in FIG. 2. In some related embodiments, the number and identity of sub-categories available in each high-level category is adjusted as the number of available advertisements grows, in order to ensure that any bottom-level sub-category (that is, any sub-category that does not itself possess sub-categories) has an adequate number of advertisements to engage user interest. In some embodiments, categories and subcategories are arranged in a directory structure format familiar to computer users, with folders containing subfolders and final categories (corresponding to advertising flows) existing analogously to files in a directory structure (for instance, a particular directory may have both subdirectories and files or final categories; only selection by a user of final categories would actually result in a user's transitioning to an advertisement viewing page). It is a key goal of the invention to provide users with an intuitive navigation interface that allows them to quickly locate sets of advertisements that are relevant to what they seek to explore (for example, new sports cars). According to embodiments of the invention, category hierarchies are stored as linked lists in configuration database 121, although they may also be stored as extensible markup language (XML) files or data elements. It should be appreciated by one having ordinary skill in the art that there are many well-established ways of adequately representing hierarchical data structures, any of which may be used in embodiments of the invention without departing from the scope of the invention.

While advertising search page 200 is primarily for assisting users in selecting categories for viewing, in most embodiments a variety of navigation and other aids for users is also provided. For example, a “My Account” button 230 takes a user, when “clicked” of activated, to a special web page that for example provides preferences specific to the selecting user, in order that such a user may review and optionally modify such preferences. Additionally, in some embodiments users are allowed, on their “My Account” pages, to provide credit card or other financial information in order to allow them to make purchases of advertised products from within advertisements displayed according to the invention. In other embodiments, users are offered incentives such as loyalty points for viewing advertisements and providing detailed information about their reactions to them; in these embodiments users are able to view their point balance on a “My Account” web page. In some embodiments, users are allowed to redeem loyalty points in order to receive discounts from participating advertisers who offer the discounts in exchange for either receiving valuable information about viewers of their advertisements, for receiving prominent placement of their advertisements in advertising flows, or for receiving discounted advertising prices from a service provider hosting an instance of the invention. In some embodiments, various combinations of these or other advertiser incentives are provided to induce advertisers to offer discounts to participating users. Similarly, in some embodiments, various incentives or combinations of incentives are offered to consumers to induce them to provide more information about themselves, their preferences, and their reactions to or ratings of advertisements, which information is useful to advertisers and to services providers hosting instances of the invention.

Other navigation aids are also provided according to some embodiments. “About” button 231 takes a user who activates or clicks it to a page describing the purpose of the site and possibly providing information about a service provider hosting the instance of the invention. A “Help” button 232 take a user to a help page which is similar in nature to Help pages known on many web sites in the art. In some embodiments of the invention, “Help” button 232 may lead to a “Frequently Asked Questions” or FAQ page, and may be labeled accordingly. In other embodiments, Help pages reached via Help button 232 may provide ticket-tracking and may provide troubleshooting tips for users although, given the straightforward nature of the user interfaces provided according to the invention, such sophisticated help functionality is unlikely to be needed. It will be appreciated by those having ordinary skill in the art that there are a number of techniques and technologies known in the art for providing “About” and “Help” pages, any of which may be used according to the invention. An optional “Hide Side Bar” button 233 is provided in some embodiments of the invention; clicking or activating a Hide Side Bar button 233 causes the “side bar” 240 to disappear from view, possibly with a slide-away effect. In embodiments incorporating a Hide Slide Bar button 233, a corresponding “Show Side Bar” button, in the same or a similar location but with arrowheads pointing to indicate its action is opposite in sense of the original “Hide Side Bar” button 233, is displayed to allow users to undo the action of the “Hide Side Bar” button 233. It should be appreciated that the exemplary navigation aids 230-233 are strictly examples of typical navigation aids provided in embodiments of the invention; more or fewer navigation aids may be provided in various alternative embodiments without departing from the scope of the invention.

In some embodiments of the invention, “Start” button 220 is provided to allow users to return to a category selection page from anywhere in an advertising flow. Similarly, some embodiments provide a “MyAds” button 221 (shown in FIG. 2 as a “MyFinagle” button, where “Finagle” is an instance of an embodiment of the invention available on the Web). Details of the page to which a user is taken when activating or clicking a “MyAds” button 221 are discussed, with reference to FIG. 7, below. In order that user-specific services and settings may be provided, most embodiments of the invention provide a user Login button 222 that take a user to a login page; it will be readily appreciated that login pages are well-known in the art and come in many configurations, any of which may be used without departing from the scope of the invention. In most embodiments, information about users and their login credentials (typically, user name and password) is stored in configuration database 121. In some embodiments, user credentials are stored as cookies or their equivalent on user devices and, when a Login button 222 is activated, the stored credentials are checked (normally by advertising server 111) against the information stored in configuration database 121 for correctness; if the information is correct, the user is “logged in” without being taken to a login page. When a user is logged in, Login button 222 normally is toggled to become a Logout button, as is commonly done in the art.

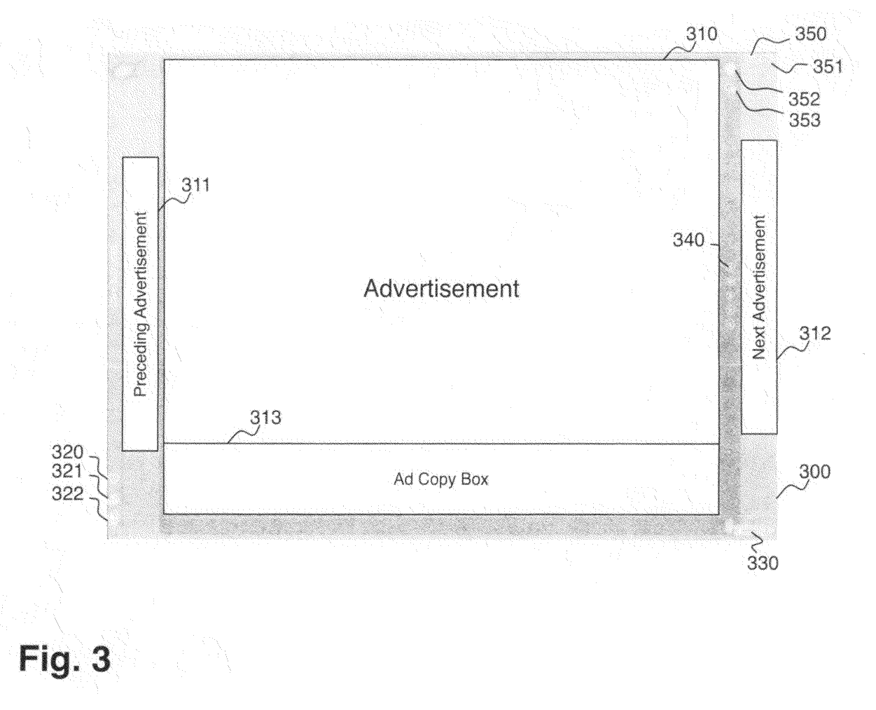

FIG. 3 illustrates a typical advertisement viewing web page 300, according to a preferred embodiment of the invention. According to the embodiment, advertisement 310 is displayed to a viewing user inside a web browser or other Internet-connected application similar to a web browser. Advertisement 310 comprises one or more of text, images of high resolution or low resolution, video or audio content embedded via use of embeddable media viewers, or interactive content (for example, a an Adobe Flash™ application), such as are well-known in the art. In some embodiments, advertisements 310 are stored in advertising server 111 or configuration database 121, although this is not necessary according to the invention. In most preferred embodiments, advertisements 310 are provided on request from third-party servers over Internet 150 or proprietary networks such as private advertising networks.

According to the invention, advertisements 310 are arranged in “flows”, or ordered sequences of advertisements 310, to users upon selection of an appropriate category. FIG. 3 illustrates a situation in which a user is viewing advertisement 310 from a non-terminal location in an advertising flow sequence. A just-previous (in terms of an advertisement flow sequence) advertisement 311 is displayed to the left of advertisement 310, and the next advertisement 312 in sequence is shown to the right of advertisement 310. In some embodiments, the orientation of “before” 311 and “after” 312 advertisements is top to bottom, and any orientation is possible according to the invention. For example, in regions where text viewing is normally right-to-left, preceding advertisement 311 may be arranged to the right of advertisement 310 and, conversely, a next advertisement 312 may be displayed to the left of advertisement 310. In preferred embodiments of the invention, visible display of preceding 311 and following 312 advertisements facilitates user navigation within an advertising flow. A user clicks or selects a previous advertisement 311 in order to “move” back to the selected previous advertisement 311 in a flow, whereupon advertisement 311 visibly slides or jumps into a main viewing position, replacing the previous advertisement 310. Similarly, a user clicks or selects an upcoming advertisement 312 in order to “move” forward to that advertisement, which then becomes the central or main advertisement 310. In most embodiments, “motion” is indicated by providing visual feedback, for example by showing a previous advertisement 311 or a subsequent advertisement 312 sliding into position as the new main advertisement 310, or by showing the transition as a jump. In some embodiments, visual feedback is augmented or replaced by audio feedback, for example by the playing an appropriate sound (such as a clicking or sliding sound to suggest selection or motion) when a user selects a new advertisement in a flow. In most embodiments, when a user is viewing an advertisement 310 that is either at the end or the beginning of a flow, the lack of a “next” advertisement 312 or a “previous” advertisement 311 is indicated simply by the lack of a corresponding visual element in web page 300. Also, most embodiments show a scaled and optionally faded copy of the leftmost edge or rightmost edge, respectively, of a subsequent advertisement 312 or a previous advertisement 311, or both, as applicable. In some embodiments of the invention, the border of previous advertisement 311 and subsequent advertisement 312 are visibly highlighted when a user's pointing device is used to move a web browser's cursor over the regions covered by the previous 311 or subsequent 312 advertisement, as a means of visual feedback to alert a user that clicking the pointing device will cause the selected advertisement to move to a central viewing position and to assume the role of main advertisement 310.

In most embodiments of the invention, the centered advertisement 310 is interactive in nature, providing users with a highly interactive experience when viewing advertising flows. In some embodiments, when a user “mouses over” (that is, moves a visual cursor over, using a mouse or other pointing device including in some cases a finger or other manual pointing device when used in conjunction with a touch screen user interface) a lower portion of an advertisement 310 being viewed, an advertising copy box 313 slides up or pops up over a lower portion of advertisement 310 (in most embodiments, the “active” lower portion which triggers this response is identical in extent with the actual lower portion region covered by ad copy box 313 when it is visible, but this need not be so according to the invention). In some embodiments, ad copy box 313 is partially transparent, in order that a user may still view the covered portion of advertisement 310 under the ad copy box 313. However, in other embodiments ad copy box 313 is opaque and completely obscures underlying advertisement 310. In some embodiments of the invention, in an upper portion of selected advertisement 310, defined usually as the portion not corresponding to the lower activation region for ad copy box 313, but not necessarily coextensive with the entire region not enclosed by the activation region of ad copy box 313, a characteristic visual cursor element different than a standard web browser cursor is provided when a user's mouse or pointing device is positioned over the upper portion of advertisement 310. When a user clicks while this characteristic visual cursor is activated, or while any cursor is active over a viewing region of main advertisement 310, a configurable action is triggered. In most embodiments, the configurable action is to navigate the user's web browser 300 to a specific web page generally associated with and selected and controlled by the advertiser whose advertisement 310 is shown. In some embodiments of the invention, any movement of a characteristic cursor, by use of a mouse or other pointing device, over the region occupied by advertisement 310, causes a lower ad copy block 313 to slide or pop up and causes a visible element to be displayed with a caption such as “Click for more”. In these embodiments, navigation to an advertiser-specified and controlled web page is executed when a user selects or clicks the captioned visible element. It should be understood that, as is well understood in the art, there are multiple ways for a web page designer to enable a user to indicate a desire to “see more” or “go there”, any of which may be used to allow a user to click through an advertisement in order to learn more about a product or service advertised in main advertisement 310. Similarly, if a media object such as an embedded video viewer is included in or as main advertisement 310, in some embodiment various play control buttons or elements may be displayed to allow a user to control the playback of a video, audio, or otherwise interactive media element of advertisement 310, without departing from the spirit or scope of the invention.

In an embodiment of the invention, various navigational and informational elements of aids are provided in advertising web page 300. For example, a “Favorite this” icon 320 is provided to enable users to specify that they wish to store the currently viewed advertisement 310 or advertisement flow (or, optionally, both, allowing a user to decide which) as a favorite. Selection of an advertisement as a favorite using “Favorite this” icon 320 will, in most embodiments, send a message to advertising server 111, whereupon the identification of a specific advertisement 310 as a favorite of a specific user is stored, typically in event database 120. Sharing icon 321 is provided, according to some embodiments of the invention, to allow a user to inform other users of advertisements 310 that she found useful. In some embodiments of the invention, when sharing icon 321 is selected by a user, a pop-up or dialog box appears that allows a user to enter, for example, a user name or email address for a plurality of users with whom the sending user wishes to share advertisement 310; in most cases, a text entry box is also provided to allow a user to type a message that will accompany notifications or emails sent to the selected other users with whom advertisement 310 is shared. In some embodiments, full screen icon 322 is provided to allow a user, on selecting full screen icon 322, to cause web page 300 to be displayed as a full-screen object. In most embodiments, full screen icon 322 will continue to be visible after a transition to full screen mode, where it acts as a toggle button; that is, when it is selected when a user is viewing in full screen mode, viewing toggles to the original size before full screen mode was engaged.

In an embodiment of the invention, slide bar 330 is used in some embodiments to allow a user to quickly scan through an advertising flow. A user may select a left arrow at or near the left end of slide bar 330 to jump directly to a first advertisement 310 in a flow, or similarly may select a right arrow at or near the right end to jump to the last advertisement 310 in a flow. If a user clicks and drags a slider element of slide bar 330, advertisements 310 are made to rapidly “fly past” the middle position of web page 300 so that, when the user stops moving the slider element, the advertisement 310 corresponding to the relative position within the flow indicated by the slider element is shown in the central position on web page 300.

In an embodiment of the invention, a set of scoring elements 340 is provided to allow viewers of advertisement 310 to “rate” the advertisement. Various rating scales and techniques, including textual ratings such as “Love It!” down to “No Way!”, may be used according to the invention. In one embodiment, as a user mouses over a particular scoring element 340 that shows a number (commonly the series of numbers from 1 to 5 is used, as shown in FIG. 3, although it need not be), appropriate text “tags” appear to indicate the meaning or sense of the number over which the user's visual cursor is present or moving. For instance, when a user mouses over the number 5, a text tag (or pop up visual element) saying “I Love It!” appears; the tag disappears when the user moves the mouse cursor away from the number (in some embodiments, the tag does not disappear for a short, possibly user-configurable, time period). In some embodiments, when a user selects a rating or scoring element 340, as for instance by clicking on it, all of the elements from the selected score downward changes colors (or are filled with color, for example in cases where the scoring elements 340 are open circles or rectangles), thus giving a visual impression of a “satisfaction meter”. For instance, if a user is impressed with an advertisement 310 and rates it as a “4” by clicking on a scoring element 340 so labeled, all of the scoring elements equal to or less than 4 change color. When a user rates a particular advertisement 310, a rating or score value is stored by advertising server 111, typically (although not necessarily) in event database 120; what is important in understanding the invention is that the score selected in one session for a particular advertisement continues to be associated with the particular user/advertisement pair until and unless the particular user changes it later in the same or another session.

In some embodiments of the invention, a return icon 350 is provided that, when selected, returns a user to a advertising category selection page 200. Optionally, a user login button 351 is provided which, when selected, causes a pop-up or dialog box to appear that allows a user to log in. User login allows user-specific settings and preferences to be used in preference to default values, and allows a user to take actions such as rating or scoring advertisements. However, it should be noted that, in some embodiments, ratings are still enabled for users who have not logged in; in these cases, any ratings entered will be attributed to an anonymous user. In some embodiments, anonymous ratings stay in effect throughout an anonymous user's current session, and after session end are averaged with a plurality of previous anonymous user ratings and stored in event database 120; in other embodiments, anonymous ratings are immediately averaged with previous anonymous user ratings and only average ratings are reflected even during the new anonymous user's current session. Login button 351, in most embodiments, follows a usage pattern common in the art, acting as a toggle button that becomes a “logout button” 351 when a user is logged in. Some embodiments of the invention provide a news feed button 352 that allows a user, by selecting it, to cause a news feed pertaining to the advertiser responsible for advertisement 310 to be displayed. News feeds can be displayed, according to the invention, in a new web page that is either opened in a new window or tab, or that replaces the advertising web page 300 when selected, or as pop-up windows that can be viewed and closed without changing the state of advertisement web page 300. Also, in some embodiments a query button 353 is provided to allow users to ask a question. In typical embodiments, when a user selects or activates a query button, a pop-up or dialog box appears that allows the user to enter a question. In most cases, questions are directed to the advertiser corresponding to advertisement 310, although in some embodiments users can direct their questions to other addressees, either by using a pull-down selection menu or by typing in an email address for the alternate query recipient. In some embodiments, a set of standard questions is made available to users via a pull-down menu or other selection means. Also, in some embodiments a list of possible query recipients is provided to users in a pull-down menu or other selection means.

It should be appreciated by those having skill in the art of web page design that there are a large number of alternate embodiments to the advertisement viewing web page 300 shown in FIG. 3, and FIG. 3 in particular should be understood to be an exemplary web page without limiting the scope of the invention.

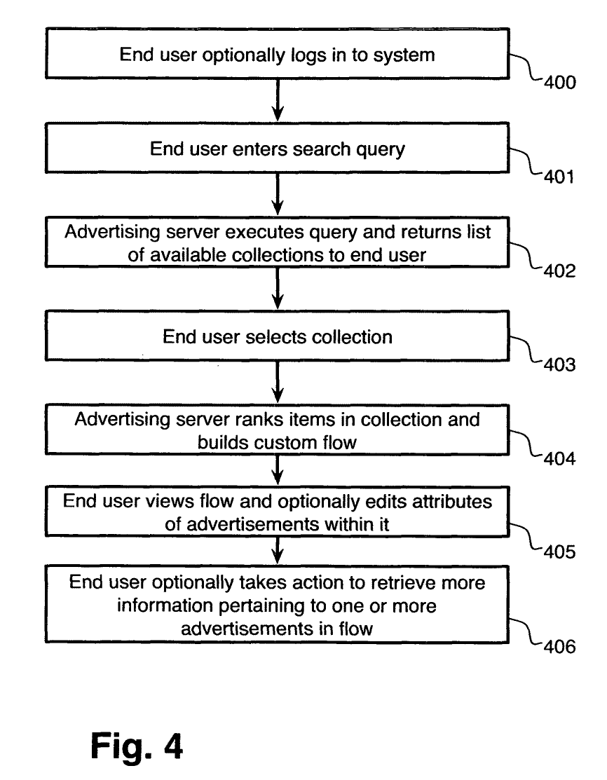

FIG. 4 illustrates an exemplary process by which an end user profitably views advertisements, according to the invention. “Profitably” is used here to describe the means for viewing advertisements illustrated in FIG. 4 as an improvement over advertisement viewing means available in the art today. Typically, users of the Internet have little or no control over the type and subject of advertisements to which they are exposed and, if a user particularly desires to view a selection of related advertisements (for example, when planning a vacation and considering various resort hotels in a desired location), she has no real means for doing so (in fact, this fact has spawned a large number of topical web sites targeted, for instance, at users trying to locate hotels). As discussed above, some users may elect to log in to an advertisement viewing system according to the invention, for example to have access to previously stored ratings and favorites; accordingly, in step 400 an end user optionally logs in to a system embodying the invention. In step 401, a user enters a search query in order to select a set of advertisements to view. This selection may be via an open-ended query, such as is provided for via the text box 210, or via other means including, but not limited to, a pull-down menu object with submenus (such as is commonly known in the art). In step 402, advertising server 111 executes an applicable search query or category lookup based on user input obtained in step 401, and returns a list of available collections (of advertisements) to end user interface 130. Various mechanisms are used, according to the invention, for selecting categories based on user query input. In some cases, where a pull-down menu or other menu is used to enable a user to select categories, their would in effect be no lookup (because the lookup of step 402 in these cases might only return the possibly renamed menu choice selected by a user; in other cases, even with a menu input means, more than one possible category might be chosen for a given menu choice). In most embodiments, step 402 will result in more than one possible category's being returned; these are displayed to the querying user, who selects one category for viewing in step 403. For example, if a user types in “cars”, she might be provided a list of categories some narrower than other, as is shown in FIG. 2.

Once a user selects a category in step 403, advertising server in step 404 ranks all of the items in the selected collection and thereby builds a custom flow, which is a sequence of advertisements that will be provided to the selecting user, with the order of advertisements in the flow (from first to last shown) is determined by the ranking function of step 404. The ranking function of step 404 is quite important, according to the invention. Various means may be used, according to embodiments of the invention, for ranking advertisements in a category. In a preferred embodiment, advertisements are ranked according to their likely relevance to a given user. Relevance can be determined in several ways, which can in turn be combined together to determine relevance more effectively. According to an embodiment, relevance is determined by comparing previous rankings or scores provided a particular user. For example, an advertisement that was given a numerical rank of 4 out of 5 (5 being very good) would be more relevant than an advertisement that was given a numerical rank of 2 out of 5. Where an advertisement has been ranked more than once previously by a particular user, the most recent rank can be used to determine the relative relevance of the advertisement, although alternative approaches such as taking an average of all of the rankings for the advertisement, or taking a weighted average in which more recent rankings are given greater weight than less recent rankings, may be used without departing from the scope of the invention. Another indicator or relevance used in some embodiments is to compare the intensity of attention given to various advertisements to be ranked by measuring one or more of the click-through rate, dwell time (time spent viewing an advertisement), deletion (hiding) or saving (“favoriting”) of the advertisements to be compared. However, since it is not typically the primary objective of the invention to get a user to click through an advertisement, as it is for search engine advertising (for example), use of click-through rates may not be as effective at judging relevance of a series of related (by common category membership) advertisements.

In a preferred embodiment of the invention, ranking of advertisements within a category is determined by price rather than relevance, more or less as if, by being in a category, an advertisement is deemed to be “relevant” on its face. It is an objective of this embodiment to encourage advertisers to spend more on advertisements in order to ensure they achieve prominent placement within a popular category. Placement according to price paid allows advertisers to make economically effective decisions with a significant degree of transparency. For example, if a manufacturer of a particular mobile phone is conducting a discount campaign to grow market share for a particular handset model, it would pay more for its advertisements placed according to the invention to ensure that a higher proportion of advertising viewers would be exposed to their discount promotion.

In some embodiments, and particularly those in which price is the determining factor for ranking of advertisements, situations will occur where a plurality of advertisements have identical ranking results. For instance, in some embodiments advertisements will be allowed at zero price (that is, they may be placed for free in a category); such free advertisements will always be placed at the end of a category, after all paid-for advertisements. But if there are many free advertisements, it is necessary for advertising server 111 to select the order for these before returning the category list to the querying user in step 404. This selection can be done by relevance, as discussed above, or merely by randomly assigning available free slots to the various free advertisements each time a viewer submits a new query (step 401). The benefit of such an approach is that a category with many advertisements with similar rankings will seem fresh each time it is viewed, as advertisements will appear in different positions. This is desirable according to the invention, as it encourages frequent revisits to familiar categories and improves the utility of the invention to end users. In some embodiments, ranking of identically-priced advertisements within a category is performed based on time since insertion of each advertisement, with newer advertisements placed near the beginning of the range of identically-priced advertisements and older advertisements near the end (or, optionally, the reverse could be selected in some embodiments, with older advertisements showing first, although this seems unlikely).

Following ranking of advertisements within a flow or category, an ordered list of advertisements corresponding to the ranked advertisements for the category selected by a user is returned to the querying user, who then views a flow (or ordered set of advertisements) in step 405. While viewing a flow of advertisements, users are able, using various navigational and informational elements discussed above, to add or alter attributes of the advertisements within the flow. Any changes are specific to the editing user, and are stored by advertising server 111 either on a local file system (that is, a file system executing on advertising server 111), or in event database 120. Examples of attributes that may be edited by users include whether an advertisement is designated a “favorite” for the user or not, ranking or rating of the advertisement (for instance using scoring element 340), deleting or hiding the advertisement (which removes it from viewing for the particular user, but not for other users), asking a question about the advertisement, or sending an advertisement to another person who may or may not be an existing user of the invention (sharing). Finally, in step 406 an end user may optionally take action, as by selecting on a “Click for more” button, to obtain more information about a product advertised in one or more of the advertisements in the selected category or flow.

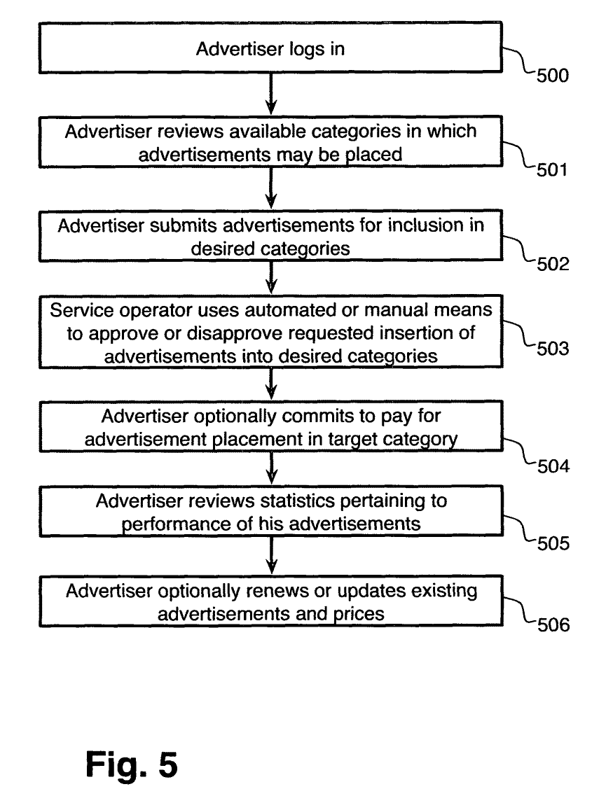

FIG. 5 illustrates an exemplary process by which advertisers interact with embodiments of the invention. Advertisers (who have established accounts as advertisers previously) first log in to the system of the invention in step 500. Advertisers seeking to place their advertisements into categories and thus to make them available for public viewing according to the invention then review available categories for advertisement insertion in step 501. In some embodiments, advertisers are provided with a query page similar to the end user advertisement search page shown in FIG. 2, in order to allow advertisers to enter phrases or keywords, such as “sports cars” in order to identify existing categories into which they may elect to insert advertisements. Alternatively, in some embodiments, advertisers locate eligible categories for advertisement insertion by using a hierarchy, either via a graphical tree structure, a menu system with nested submenus to capture the hierarchy, or any other graphical or textual means for traversing a hierarchy in order to locate desires categories. It will be appreciated by one having ordinary skill in the art that there are any number of ways of representing hierarchical data that allow users to find particular elements within the hierarchy, any of which (or indeed any combination of which) may be used by advertisers to locate desirable categories. In some embodiments, advertisers are allowed to suggest new categories, which are either created immediately and made available to the suggesting and other advertisers, or are made available following a subsequent review by a service provider to determine suitability or desirability, or both, of the suggested new category. Having selected at least a category into which it is desired for an advertisement to be inserted, advertisers in step 502 submit advertisements, individually or in groups, for inclusion in particular categories. Advertisements, or groups of advertisements, are optionally submitted for inclusion in one or several categories; in the case of multiple insertions, this is done by using multiple selection techniques well-known in the art of user interface design.

Once an advertisement has been submitted for inclusion in a category, in step 503 a service operator responsible for managing an advertisement viewing service according to the invention makes a decision whether to approve, disapprove, or defer decision on, submitted insertion requests. In some embodiments, “approval” will be automatic, and advertisers receive an immediate approval (and in some embodiments, step 503 is omitted altogether). In other embodiments, an automated review process is initiated on submission of requests for insertion of advertisements, in step 503. Automated reviews include, in various embodiments, a variety of decision elements based on consideration of various indicators of desirability of allowing a requested insertion. For example, a credit check of a requesting advertiser could be conducted to determine financial suitability of the advertiser. In another embodiment, advertisements are screened for unsuitable language or graphical content automatically, for instance if an advertising service is being operated by an entity that desires to avoid particularly graphic violence or sexual content, in order to protect its viewers, its brand, or to reduce its potential legal liability, or for any combination of these or other reasons. In yet other embodiments, reviews may include consideration of the relative dominance by one advertiser of the advertisements in a single category (for instance, if 70% of the advertisements in a car category were from one manufacturer, a service provider might automatically decide to refuse additional advertisements from that manufacturer for that single category). In some embodiments, categories are limited in size to prevent their becoming overwhelming to users, and requests for submission of additional advertisements in these categories may be denied when the number of advertisements already in the category meets or exceeds a specified maximum size. In yet other embodiments, requests are reviewed automatically to ensure suitability of the media to be included as part of advertisements requested to be inserted. For example, some categories might be restricted to exclude video content, or limitations on the image or file sizes, or both, of graphical elements may be imposed. In some embodiments, manual reviews either replace or augment automated reviews, particularly when human judgment in evaluating suitability of content of proposed advertisements is deemed necessary or advisable by a service provider. For example, in some cases it may be difficult or impossible for automated systems to detect offensive statements made in advertisements, yet it would be quite straightforward for humans to do so. Because human reviews are much less efficient and may result in significant system delays and loss of advertiser interest, in some embodiments human reviews take place after provisional approval, and human reviewers revoke provisional approval of advertisements that are deemed unsuitable. It will be understood by those having ordinary skill in the art that there are a variety of combinations of human and automated reviews, and of the sequence of such reviews, that can be enacted by various service providers according to the invention without departing from the scope of the invention.

When requested advertisement insertions are approved, advertisers in step 504 optionally commit to pay to place their advertisement or advertisements in approved categories. Advertisers may elect to pay nothing for their advertisement placement, in which case their advertisement will be included in the lowest-ranked group of advertisements in that category (among the “free” advertisements in a category, and as discussed before, rankings can be determined by a variety of means, and similarly each group of identically-priced advertisements will be arranged according to some criterion such as, but not limited to, those described above). Advertisers wishing to achieve more prominent placement for their advertisements choose to pay to place their advertisements, and advertisers choose the amount they wish to pay based on their assessment of the tradeoffs between cost and placement. In some embodiments, advertisers are provided, via information passed from advertising server 111 to advertiser interface 140, with particular information about expected placement locations of a proposed advertisement at various possible prices. Such an information feed will allow advertisers to carefully, either automatically or via a human user interface, evaluate the tradeoff between price and placement. Advertisers will in general be aware that other advertisers will have access to the same information (although, in some embodiments, advertisers may pay extra fees to services providers to receive a premium information flow to allow them to “see more” than non-paying competitors), and therefore a de facto market mechanism is set up according to the invention in which advertisers will naturally, in the presence of adequate numbers of competitors, find appropriate price points for advertisement placement within a given category. In some categories that are very popular and potentially lucrative (that is, the potential revenue generated per advertisement view is higher than normal, as perhaps in a luxury car segment), prices will tend to be higher and few advertisements will be displayed at no cost. In other, less prominent or lucrative categories, virtually all of the advertisements may be “free placement” advertisements. It should be noted, however, that such a situation is not necessarily disadvantageous to a service provider, as there is inherent value in having a large number of well-populated advertisement categories, since this will make a service provider's offering according to the invention attractive to consumers; if there are only a few categories with expensive advertisements, it is unlikely that enough viewers would be attracted to make the advertisements pay off. Clearly the inventor has identified that an important element of the invention is its ability to stimulate large-scale advertisement placement (through provision of free or inexpensive access to a rich advertising modality), in order to thereby stimulate a large consumer viewership that sees the advertisements, which in turn causes advertisers to compete for optimal placing and thereby creates a revenue stream for a service provider operating an advertising platform according to the invention. In some embodiments of the invention, payment is not optional, but rather various price points are made available by a service provider for each category, each corresponding to a particular range of placements within the category (generally, but not necessarily, highest-priced advertisements are arranged at the beginning of the category's flow, and lowest-priced advertisements at the end, and so forth). In yet other embodiments, service providers may in effect run auctions for advertisement placement slots. For instance, advertisers in one embodiment of the invention may “bid” up to a certain price for first position in a category, in the hope that no other advertisers will outbid them. If an advertiser bids $3.00 and the highest bid from a competitor if $1.95, then the high bidder would get the desired advertisement placement slot for $1.96 or $2.00 (depending on the minimum increment; other choices are of course possible within the invention).

In yet other embodiments, service providers provide complex capabilities to advertisers, such as by allowing an advertiser to state an overall campaign cost allowance per day, week, or month, and to specify certain parameters about how the cost is to be allocated across various advertisements within a campaign (or across placements of the same advertisement or group of advertisements in several different categories), and about the goals of the advertiser for each campaign (for example, a goal could be that 10% of advertisement placements should be in the top position of a category, or that when a certain class of consumers elects a particular category, the advertiser's advertisements should always be in first position); in such situations, pricing server 112 then determines a price for each advertisement and its position in order to optimally meet the constraints set by the advertiser.

In some embodiments of the invention, pricing server 112 executes a competitive pricing algorithm to encourage adoption of services using the invention by advertisers while ultimately generating satisfactory revenue streams to those services. According to one embodiment, when a new or existing category has an inventory of active advertisements below some configurable (configuration stored in configuration database 121 or equivalent) threshold, then advertisements in that category are free (although advertisers may still be provided an option to pay a premium price for prominent placement). Once the inventory of advertisements for the category rises above the threshold, pricing server 112 begins computing new prices for each new advertisement submitted to the category, with a generally upward trend (more advertisements means higher prices, although any mathematical algorithm, such as a linear function of n, where n is the number of advertisements in the category, and where price is zero when n is below a threshold) can be used to set the price without departing from the embodiment. In some embodiments, thresholds are set differently going up (from zero price to non-zero as inventory crosses a threshold) and down (when inventory drops below a threshold and all new prices drop to zero; in this case, optionally all existing prices could also be dropped to zero), to insert hysteresis into the system. An objective of embodiments such as that just described is to encourage advertisers to insert advertisements in lightly-loaded categories by making them free, and then encouraging others to join the category before prices escalate, as it is assumed that users will often tend to select categories with many advertisements and richer viewing experiences.

Advertisers will require regular information on the performance of their advertisements (that is, the number of views, dwell time, click through, ratings, and other metrics of consumer interest, preferably sortable by consumer segment), and the costs of their advertisements and advertising campaigns. In step 505, advertisers review statistics provided by advertising server 111 via advertiser interface 140 in one of a variety of modes well-known in the art. In some embodiments, advertisers are provided a reports web page which allows them to create custom reports and to view them. In other embodiments, advertisers are given access to their data via an application programming interface (API) accessed via advertiser interface 140 in order to allow advertisers to integrate information about their advertisements and campaigns into applications developed by the advertiser or by a third-party (for instance, information could be imported into commercial third-party advertising software programs using an API according to the invention). In some embodiments, advertisers are provided with graphical data to allow trends to become evident, and in some embodiments derivative information, such as the correlation of probability of viewing with price paid, is provided by advertising server 111 to advertisers via advertiser interface 140. Such derivative information is very helpful to advertisers, as it allows them to objectively evaluate various strategies they may pursue as they consider future campaigns.

Finally, in step 506 advertisers optionally renew or update existing advertisements and their prices. In some embodiments, advertisers place a time limit on a particular advertisement or campaign (group of related advertisements) when they set it up. In other embodiments, a maximum total price is established when an advertisement is placed or a campaign started. In yet other embodiments, time and cost limits are combined, such that an advertisement or campaign “expires” after a certain time or when a maximum total cost level is reached. In each of these cases, an advertiser will be informed (via a message from advertising server 111 to advertiser interface 140) that their advertisement or campaign has expired (or that it is about to expire), and the advertiser may elect to renew the advertisement or campaign. Also, advertisers may elect to change the price they are willing to pay for a given advertisement after some period of time has elapsed, perhaps in response to a lack of adequate viewership, or perhaps because the advertiser concludes it can safely lower the price paid while still maintaining adequate viewership. In some embodiments, a service provider providing advertising placement services according to the invention may elect to place limits on how often, or specifically when, an advertiser may change prices on active advertisements; in other embodiments, advertisers are free to adjust prices any time, with all views by consumers subsequent to the change reflecting the new price.

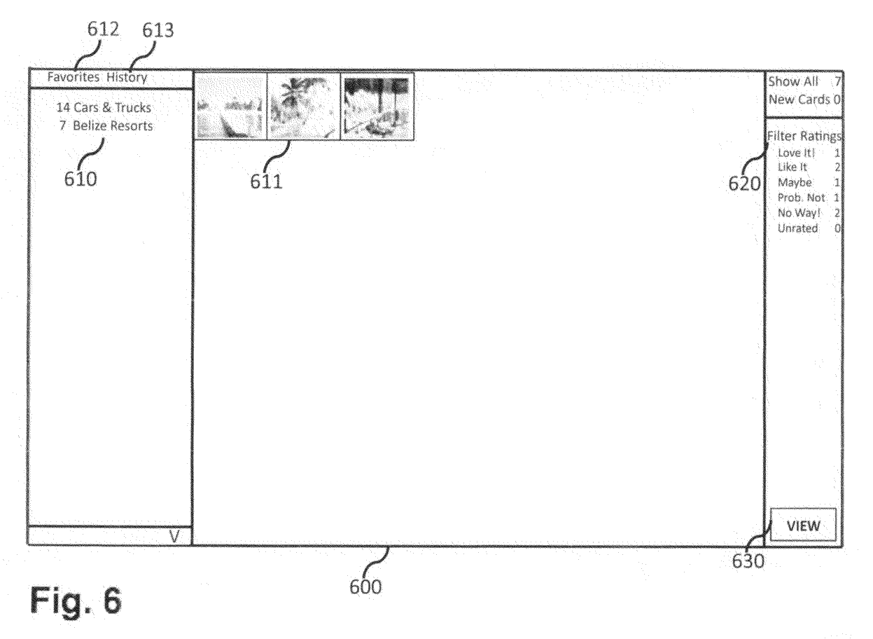

FIG. 6 illustrates a personalized advertisement web page 600 according to an embodiment of the invention. Pages such as that illustrated in FIG. 6 are useful to consumer to aid them in placing a plurality of viewed advertisements in context, for example to aid in comparisons of like products or services. Such pages are typically reached by the selection by a user of a “My Page” icon on any of the other pages provided by a service provider according to the invention, such as advertising search query page 200 or advertisement category viewing page 300. Personalized advertisement web page 600 comprises, in an embodiment, one or more category selection tabs 610. Category selection tab 610 lists categories that have been viewed recently, when history button 613 is active, or categories that have been marked as favorites, when favorites button 612 is active. When a user selects one of the categories displayed in category selection tab 610, a set of “cards” 611, or thumbnail-like representations, one of each advertisement within the selected category is displayed. Cards 611 for hidden (or deleted, although as mentioned before the advertisements are only “deleted” for a particular user) advertisements are not displayed in most embodiments, since the purpose of the personalized advertisement web page 600 is to provide a page where all of the advertisements that a particular user has found useful in the past. In some embodiments, if a user mouses over a card 611, the card image toggles to an advertisement title, and card 611 reverts to an image representation when the user moves her mouse off of card 611.

In preferred embodiments of the invention, various filter tools 620 are provided to allow a user to filter advertisements within a category; when a user is using a filter, all advertisements from a category that do not satisfy the filter's conditions are removed from viewing and no cards 611 for those particular advertisements are shown. Examples of filtering commands include, but are not limited to, filtering by user ratings or filtering by age (new cards 611 only, for example, as shown in FIG. 6 with the “New Cards” button). In filtering by ratings, as an exemplar of other possible filtering approaches, users select one or more of the available ratings buttons (using user interface conventions such as “control-click” for multiple selections), and all advertisements that were given one of the selected ratings are displayed. In some embodiments, each rating “radio button” acts as a toggle switch, so that users can add or drop ratings from their filter selection with single mouse clicks, with immediate feedback (meaning cards 611 are immediately added or dropped as indicated by the changed filter settings). Other filter types are possible within the scope of the invention, including for example (but not limited to) filtering by advertiser (for categories such as automotive, this would likely be a common choice, allowing comparison of different automotive brands in side-by-side fashion), location (for example, by selecting hotel advertisements from different parts of London; this could alternately be accomplished by a service provider's or an advertiser's creating subcategories within “hotels in London”). As in other pages illustrated and described herein, a variety of navigation aids may be provided in personalized web pages 600. An example of a navigational aid is view button 630, which takes a user to an advertisement category viewing page 300 corresponding to a selected category.

There are many additional features that will occur to those having ordinary skill in the art of web page design that may be added to those exemplary features described herein. For example, users may be allowed, in some embodiments, to “tag” advertisements with attributes such as “cool car”, “convertible”, “high-rise hotel with sky bar”, and so forth. Such tags may be kept as confidential information attributes available to a single user, and used in filtering on personalized advertising web page 600, or they may be shared among users and even used as query terms in advertising category query or search page 200.

It should be understood that all embodiments disclosed herein are exemplary in nature and should not be construed to eliminate equivalent embodiments.

What is claimed is:

1. A system for managing online advertisements, comprising:
a network-connected communications interface operating on a server and adapted to receive information from an end user interface and from an advertiser interface;
an advertising server coupled to the communications interface;
a pricing server coupled to the advertising server and to the communications interface; and
a database coupled to the advertising server and the pricing server;
wherein the pricing server, upon receiving a request for a price for a proposed online advertisement pertaining to a specific advertisement category from an advertiser interface, computes a price based at least in part on an indicia of available supply of advertisements pertaining to the category, said indicia obtained from the database, and provides the computed price to the requesting advertiser interface; and
wherein the advertising server, on receiving a request for online advertisements pertaining to a particular advertisement category from an end user interface, retrieves all or a substantial portion of advertisements pertaining to the advertising category from either the database or a data storage subsystem associated with the advertising server, and provides the retrieved advertisements or links thereto to the requesting end user interface; and
wherein the advertising server further provides to the requesting end user interface indicia pertaining to an order or method of display to be used in presenting the retrieved advertisements at the requesting end user interface, wherein the indicia provided are determined at least in part based on user-specific information stored in the database.

2. A method for managing online advertisements, comprising the steps of:
(a) at a pricing server, receiving a request from an advertiser interface via a communications interface for a proposed online advertisement pertaining to a specific advertisement category;
(b) computing a price based at least in part on an indicia of available supply of advertisements pertaining to the category, said indicia obtained from a database coupled to the pricing server and to an advertising server;
(c) providing the computed price to the advertising interface;
(d) receiving a request for online advertisements pertaining to an advertising category from an end user interface at the advertising server via the communications interface;
(e) retrieving all or a substantial portion of advertisements pertaining to the requested advertisement category from the database;
(f) providing the retrieved advertisements or links thereto to the requesting end user interface; and
(g) providing to the requesting end user interface indicia pertaining to an order or method of display to be used in presenting the retrieved advertisements at the requesting end user interface, wherein the indicia provided are determined at least in part based on user-specific information stored in the database.
